(19) United States
(12) Patent Application Publication
(10) Pub. No.: US 2021/0209296 A1
(43) Pub. Date: Jul. 8, 2021

(54) AUTOMATIC PROPAGATION OF COLUMN VALUES FROM A SOURCE APPLICATION TO MULTIPLE DESTINATION APPLICATIONS

(71) Applicant: SmartSheet, Inc., Bellevue, WA (US)

(72) Inventors: Bhanu Prakash, Kirkland, WA (US); Ben Canning, Redmond, WA (US)

(73) Assignee: SmartSheet, Inc., Bellevue, WA (US)

(21) Appl. No.: 16/734,177

(22) Filed: Jan. 3, 2020

(51) Int. Cl. G06F 40/18; G06F 9/451

(52) U.S. Cl. CPC G06F 40/18; G06F 9/453

(57) ABSTRACT

This disclosure relates to a method executed on a computer server in a data communication network. First, a source column identifier and a source spreadsheet identifier may be received from a source spreadsheet application. An extended column address comprising the source column identifier and source spreadsheet identifier may then be published. Next, the extended column address may be made selectable by at least one destination spreadsheet application over the data communication network. Then, a selection of the extended column address and a destination column identifier in a destination spreadsheet may be received from the at least one destination spreadsheet application. Finally, the destination column may be associated with the extended column address such that values of the source column are presented in a dropdown list for cells of the destination column in response to activation of cells of the destination column in the destination spreadsheet application.

### BACKGROUND

Many business processes cannot be modeled in a single spreadsheet. Multi-spreadsheet applications may utilize dropdown list values that need to be consistent across the different spreadsheets. For example, if one or more values in a master project spreadsheet are changed, and these values are used in dropdown lists in many other spreadsheets, the other spreadsheets need to each be updated with the changes. Conventionally this is done manually. The manual duplication of dropdown list values into many (up to hundreds or even thousands, potentially) of different spreadsheets is laborious and provides many opportunities for data entry errors. The problem also presents itself when master dropdown list values are changed, added, or removed.

Conventionally there exists no efficient and robust mechanism to populate a dropdown list in one spreadsheet with values in a column in a different (e.g., master) spreadsheet. Conventional spreadsheet solutions may support the ability to import dropdown values from one spreadsheet to another, and develop dependencies upon those values, but these tasks must be performed in the destination spreadsheet manually. There are no solutions providing a central master sheet allowing updates to be made in a single place with consistent application across all sheets using those values. Configuration to mimic the desired functionality may require complex configurations of the spreadsheets or intricate formulas, all of which may be easily rendered inoperative by configuration changes such as renaming, opening, or closing a file. There is, therefore, a need for a spreadsheet solution providing automatic, dynamic update capabilities for dropdown lists across multiple spreadsheets.

### BRIEF SUMMARY

This disclosure relates to a method for propagating column values from a source spreadsheet application to multiple destination spreadsheet applications. A source column for a dropdown list may be defined within a source spreadsheet application. An extended column address for the source column may be formed using a spreadsheet identifier for the source spreadsheet application and the source column. The extended column address may then be published on a link server. A destination column may be associated with the extended column address in a destination spreadsheet. Values from the source column dropdown list may be presented in response to activation of cells of the destination column in the destination spreadsheet application.

This disclosure further relates to a method executed on a computer server in a data communication network. A source column identifier and a source spreadsheet identifier may be received from a source spreadsheet application. An extended column address comprising the source column identifier and source spreadsheet identifier may then be published. The extended column address may be made selectable by at least one destination spreadsheet application over the data communication network. A selection of the extended column address and a destination column identifier in a destination spreadsheet may be received from the at least one destination spreadsheet application. The destination column may be associated with the extended column address such that values of the source column are presented in a dropdown list for cells of the destination column in response to activation of cells of the destination column in the destination spreadsheet application.

This disclosure further relates to a non-transitory computer-readable storage medium including instructions that, when executed, cause the computer to perform the following actions. An extended column address is formed from a source column identifier and a source spreadsheet identifier is published. A selection of the extended column address and a destination column identifier in a destination spreadsheet are received from the at least one destination spreadsheet application. Values of the source column are propagated to a dropdown list presented for cells of the destination column.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts a distributed spreadsheet application environment 100 in accordance with one embodiment.

FIG. 2 depicts a spreadsheet application linking routine 200 in accordance with one embodiment.

FIG. 3 depicts a spreadsheet application linking routine 300 in accordance with one embodiment.

FIG. 4 illustrates an application interface for linking spreadsheets 400 in accordance with one embodiment.

FIG. 5 depicts an application interface for linking spreadsheets 500 in another aspect.

FIG. 6 depicts an application interface for linking spreadsheets 600 in another aspect.

FIG. 7 depicts an application interface for linking spreadsheets 700 in another aspect.

FIG. 8 depicts an application interface for linking spreadsheets 800 in another aspect.

FIG. 9 depicts an application interface for linking spreadsheets 900 in another aspect.

FIG. 10 illustrates a diagrammatic representation of a machine 1000 in the form of a computer system within which a set of instructions may be executed for causing the machine to perform any one or more of the methodologies discussed herein, according to an example embodiment.

FIG. 11 illustrates a client server network configuration 1100 in accordance with one embodiment.

### DETAILED DESCRIPTION

Disclosed herein are techniques for write-once, use-anywhere dropdown functionality in software applications that enables a defined list in one spreadsheet to populate dropdown lists in many other spreadsheets. These techniques provide improved efficiency and reliability for the operation of distributed spreadsheet applications by providing the automatic distribution and presentation of user interface features and functionality from a centralized application configuration source.

Values in dropdown lists are populated into multiple destination spreadsheet applications from a different source spreadsheet application. Filter criteria may be configured such that only values matching the filter criteria are displayed in the dropdown. Filter criteria may be based on column values within each particular destination spreadsheet, enabling the filtering of contents of the dropdown lists on a per-destination spreadsheet basis.

An extended column address may be configured for populating values in dropdown lists. The extended column address includes a spreadsheet identifier for a source spreadsheet and a column identifier for a column within the source spreadsheet. In one embodiment, a single-select or multi-select destination column is configured in a destination spreadsheet. The source spreadsheet and source column are configured to supply the values for a dropdown list for each cell in the destination column of the destination spreadsheet. Each cell in the newly configured destination column may then be populated from a dropdown list of values extracted from the source column. The dropdown list for cells of the destination column may be filtered. The dropdown list values in one destination column may be filtered based on a selection of another destination column. For example, a “Car Make” destination column may display a dropdown list of car manufacturers. A different “Car Model” column may automatically restrict the available car models presented in its dropdown list based on a selected value in the “Car Make” destination column.

The following configuration settings may be applied when configuring a destination column:
Configure local values for dropdown lists in the destination column on values from a source column in a different, source spreadsheet application.
Filter configured values for a dropdown list in the destination column according to a filter criterion that may depend on values in another column. For example a Sales department may track deals by geographic region and may create multiple spreadsheets per region. Each regional office may configure a dropdown list for a destination column in their particular destination spreadsheet populated from a ‘Region’ source column in a master source spreadsheet configured by the home office. The destination spreadsheet may filter the dropdown list values that are presented in their particular destination spreadsheet based on a Region Head value for their region that's configured in their destination spreadsheet. In another example, selecting “Massachusetts” from a dropdown list in a “State” column can restrict values presented in a dropdown list in a City column to only those cities that are in Massachusetts.
Configure the dropdown list to update with changes to the source column or not.

Example source column values (which may derive from the evaluation of formulas that reference other cells) are text, numbers, dates, contacts, and Booleans (YES/NO, TRUE/FALSE, selected/unselected, etc.). Permissions may also be set at a column and row level such that operators who do not have permission to view data in some dropdown columns or their dependent columns may not have visibility to protected data, while related unprotected data in those columns and rows may still be accessible.

In cases in which data may be time sensitive, a change may be scheduled to be implemented in a master source spreadsheet at a particular time. Once that change is made in the source spreadsheet, it may then propagate to destination spreadsheets. For example, if a set of department names will be changed as a result of a reorganization scheduled to be put in place officially on January 1 of the next year, logic may be configured to update the source spreadsheet at midnight of that day, after which destination spreadsheets will update with the new information automatically at the scheduled time.

The propagation of changes to values in the source column may also be controlled by a configuration setting in the destination spreadsheet. For example, by default a change to the values in the source column may propagate to be reflected in the values of a dropdown list in the destination column of the destination spreadsheet. However, the operator of the destination spreadsheet may configure a value to suppress the propagation of these changes, in which case any previously selected values in the destination column of the destination spreadsheet will not automatically update. A tool tip or other user interface feature may be presented to alert the operator in the event that values in the source column are changed, deleted, or added.

For value changes configured to propagate automatically, destination spreadsheets containing values that were changed in the source column may be updated whether or not the destination spreadsheet is in active use (meaning, is opened in a spreadsheet application). Destination spreadsheets may be configured such that updates to dropdown list values are not made automatically but may be accepted or rejected by an operator upon opening the destination spreadsheet, or through a notification dialog that a dropdown list value has incurred or will incur a change. A notification as to which changes were made may also be configured to appear when a spreadsheet is opened after an automatic update, or when an update is made to an active spreadsheet.

In one embodiment, a source column for dropdown lists in destination spreadsheets may be packaged as a “favorite” that may be efficiently incorporated into destination spreadsheets. An operator of the source spreadsheet may define and package a source column into a favorite, and operators of individual destination spreadsheets may then incorporate the favorite into one or more destination column of the destination spreadsheet. For example, when a company wants to manage project for a large number of retail stores, they may create destination spreadsheets for managing a subset of those stores by simply importing the favorite into each destination spreadsheet. Packaging the source column as a favorite enables the operator of the source spreadsheet to change the source column to a different column in a same or different source spreadsheet without disrupting the destination columns that are dependent on the source column.

The destination spreadsheet may present an indication of the source (source spreadsheet and/or source column) of dropdown list values. If the destination spreadsheet is utilizing multiple dropdown lists from different source spreadsheets, this indication may assist the operator with managing the destination spreadsheet.

In some embodiments, bi-directional update of the dropdown list values is enabled from the destination spreadsheets. If a destination spreadsheet operator adds, changes, or deletes a value in the dynamic dropdown list in the destination spreadsheet, the changes propagate to and update the source column. The ability to update values bi-directionally may be configured via a setting in the source spreadsheet with fine-tuned permissions to add, update, or delete dropdown list values from all or particular destination spreadsheets.

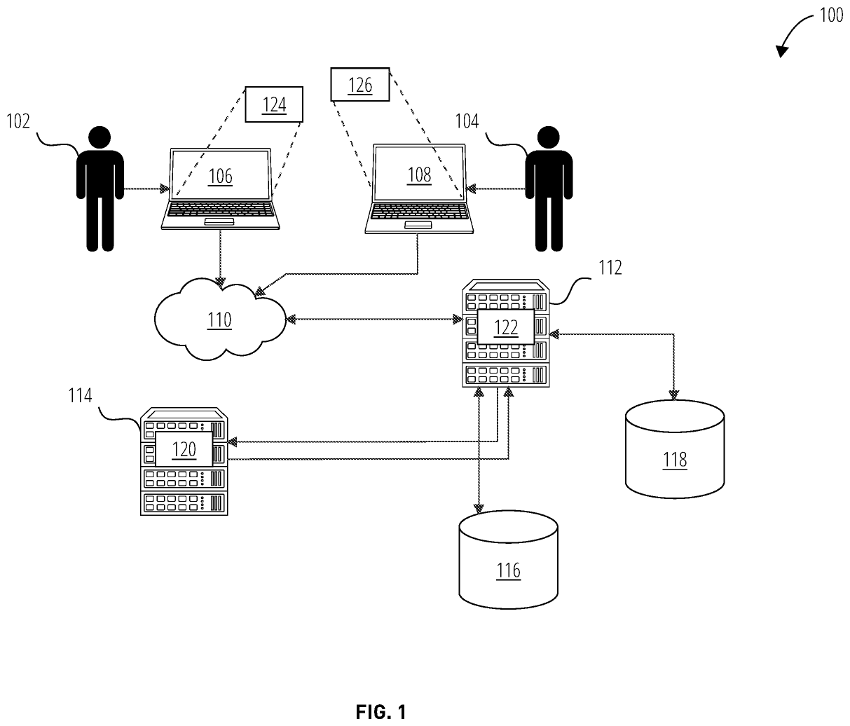

FIG. 1 depicts a distributed spreadsheet application environment 100 in one embodiment. At a high level, the distributed spreadsheet application environment 100 comprises a source spreadsheet application machine 106, a destination spreadsheet application machine 108, a spreadsheet server 112, and a link server 114. The source spreadsheet application machine 106, destination spreadsheet application machine 108, a spreadsheet server 112 may be in communication with each other over a data communication network 110. The spreadsheet server 112 may communicate directly with the link server 114 via a wired connection, for example in data center applications. In more distributed embodiments, the spreadsheet server 112 and link server 114 may communicate over the data communication network 110. For small-scale applications, the spreadsheet server 112 and link server 114 may be embodied by logic on a single physical server machine.

Those of ordinary skill in the art will appreciate that the distributed spreadsheet application environment 100 would typically include many other components that are not important to describing the depicted embodiment.

A source spreadsheet operator 102 may operate the source spreadsheet application 124 running on the source spreadsheet application machine 106 in order to create or update a source spreadsheet comprising columns of values for use in dropdown lists across a plurality of other spreadsheets. The source spreadsheet may be stored in a grid database 116 managed by a spreadsheet server 112. The grid database 116 may store spreadsheet configurations (“grids”) for a plurality of source and destination spreadsheets. A cached history and/or quick access to frequently used grids may be provided through use of the grid cache 118. The grid database 116 and grid cache 118 may be allocated partitions of non-volatile and/or volatile memory on the spreadsheet server 112 for small scale applications or may be embodied within one or more server farms or on cloud-based memory for larger, more widespread use cases.

A destination spreadsheet operator 104 may operate a destination spreadsheet application 126 running on the destination spreadsheet application machine 108 in order to create or update a destination spreadsheet. The destination spreadsheet operator 104 may select a source spreadsheet, available over the data communication network 110 from the spreadsheet server 112 as an extended column address 120, in order to automatically incorporate a dropdown list of values from the source spreadsheet into a dropdown column of their destination spreadsheet. The destination spreadsheet may also be maintained by the spreadsheet server 112 and stored in the grid database 116. When data from a source spreadsheet is added to a destination spreadsheet, the spreadsheet server 112 may utilize spreadsheet application linking logic 122 in order to form an auto-updating link between the source column of the source spreadsheet and the destination spreadsheets. Configurations of links between spreadsheets may be stored and maintained on the link server 114. This information may be embodied in the form of a link table comprising one or more extended column address 120, or as favorites, for example.

In this manner, changes made by the source spreadsheet operator 102 at the source spreadsheet application machine 106 may be distributed throughout destination spreadsheets as associated by the link server 114, through action and intermediation of the spreadsheet server 112. Changes to source spreadsheets reflected in the grid database 116 may be displayed in the linked destination spreadsheets along with any notifications explaining or alerting to the changes. These changes and notifications may appear as user interface elements (modal boxes, tool tips, text boxes etc.) to the destination spreadsheet operator 104 in the destination spreadsheet application machine 108.

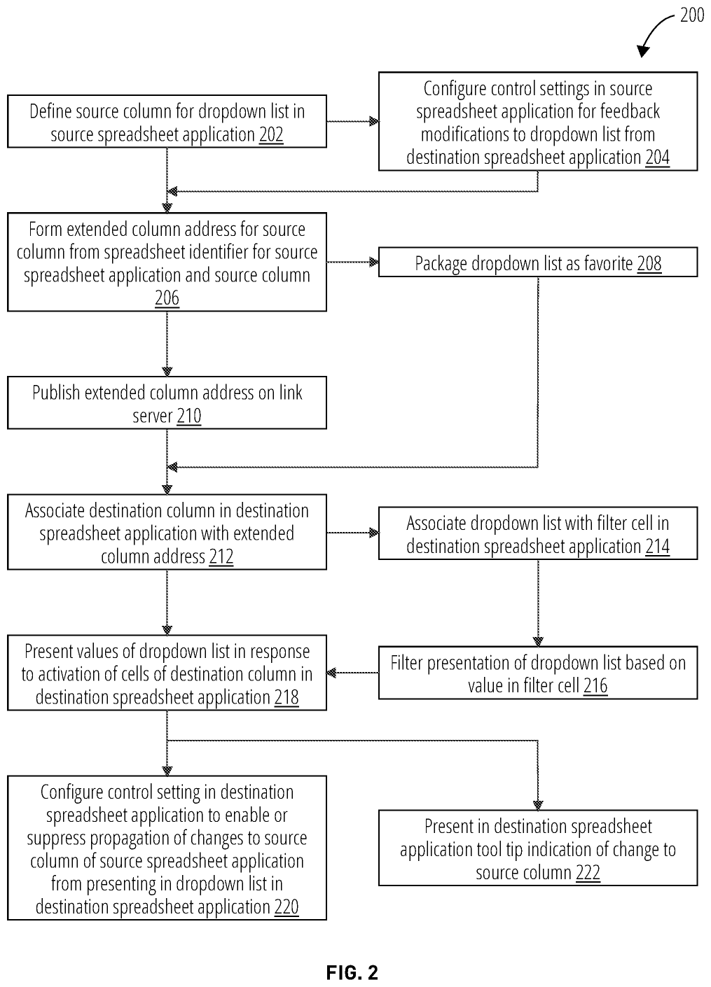

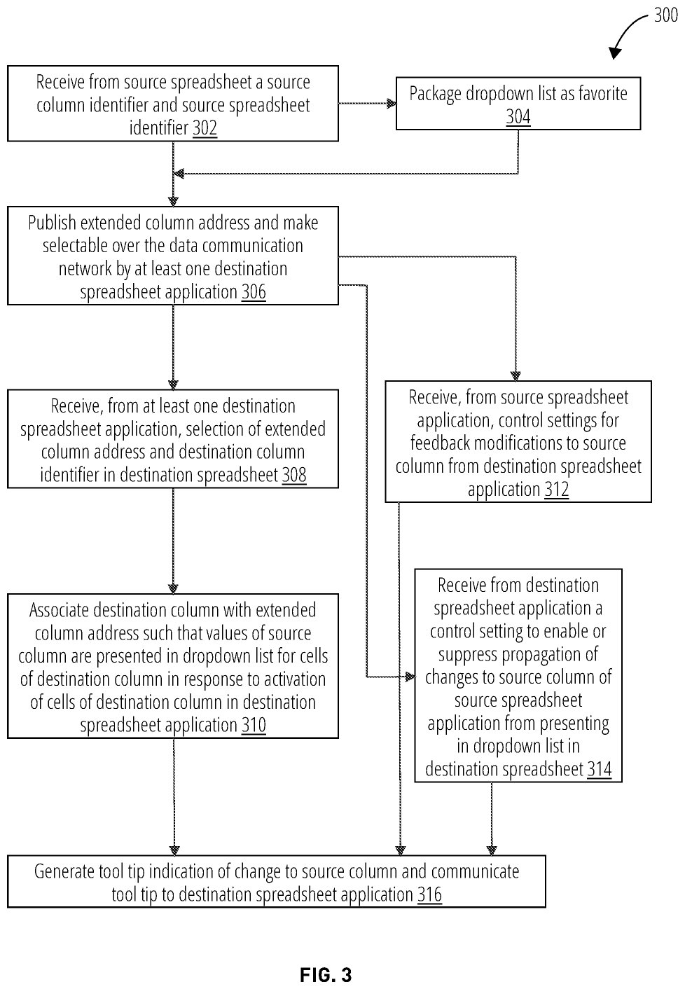

The distributed spreadsheet application environment 100 may in one embodiment operate according to the processes depicted in FIG. 2 and FIG. 3.

FIG. 2 depicts a spreadsheet application linking routine 200 in one embodiment. The spreadsheet application linking routine 200 operates to support use of centrally defined columns of dependent spreadsheet data across multiple spreadsheets, automatically updating all instances when a central source instance is modified. The actions depicted should not be presumed to occur in the order presented, unless an action depends on the result of a previous action to be carried out. If two or more actions are not conditioned on one another in some way, one skilled in the art will readily ascertain that they may be carried out in parallel, in a time-division fashion, or in a different order.

At block 202, a source column for a dropdown list may be defined in a source spreadsheet application. This action may be carried out for example by the source spreadsheet operator 102 operating the source spreadsheet application 124 on the source spreadsheet application machine 106, first introduced in FIG. 1. At block 204, control settings may be configured in the source spreadsheet application for feedback modifications. These control settings may allow or prohibit changes in a destination spreadsheet made through a destination spreadsheet application to be fed back to the source spreadsheet.

At block 206, the newly defined source column and related control settings may be utilized to form an extended column address for the source column, for example <source spreadsheet id: source column id>. The extended column address may be created from a spreadsheet identifier for the source spreadsheet application and the source column. This action may be carried out by the spreadsheet server 112 introduced in FIG. 1. At block 208 the dropdown list may further be packaged as a favorite for additional ease of future use. This may also be performed by the spreadsheet server 112 based on control settings configured at block 204.

At block 210, the extended column address 120 created in block 206 may be published on a link server 114, as described with regard to FIG. 1. This may be accomplished through the interaction of the spreadsheet server 112 and the link server 114 in known manners.

At block 212, a destination column in a destination spreadsheet application may be created through selection of the source column defined in block 202 by the actions of a destination spreadsheet operator 104, as shown in FIG. 1. This destination column may be associated with the extended column address by action of the destination spreadsheet application 126, introduced in FIG. 1.

Through operation of the destination spreadsheet application 126 by the destination spreadsheet operator 104, the dropdown list may be associated with a filter cell at step block 214. The presentation of the selected dropdown list at block 216 may be based on the value in the filter cell associated in block 214. In various embodiments the filter cell may be located in a same or different spreadsheet, and/or same or different column, than the dropdown column. This action may be performed by the destination spreadsheet application 126.

An exemplary algorithm for applying a filter cell to a dropdown list is:

on selection of dropdown cell:

for each item in dropdown list:

if evaluate(item, filter cell condition) == true then

display item in dropdown list

else don't display item in dropdown list

As a result of the actions in block 212, in conjunction with actions in block 214 and block 216, dropdown list values may be presented at block 218 in response to activation of destination column cells in the destination spreadsheet application 126.

At block 220, a control setting may be configured in the destination spreadsheet application 126 to enable or suppress propagation of changes to the source column of the source spreadsheet application 124 from presenting in the dropdown list in the destination spreadsheet application 126. When changes are made to the source column, the destination spreadsheet application 126 may act at block 222 to present a tool tip or other notification indicating a change to the source column.

FIG. 3 depicts a spreadsheet application linking routine 300 in one embodiment. The spreadsheet application linking routine 300 operates to support use of centrally defined dropdown lists across multiple spreadsheets, automatically updating all linked spreadsheet instances when a central source column value is added, deleted, or modified. The actions depicted should not be presumed to occur in the order presented, unless an action depends on the result of a previous action to be carried out. If two or more actions are not conditioned on one another in some way, one skilled in the art will readily ascertain that they may be carried out in parallel, in a time-division fashion, or in a different order.

At block 302, a source column identifier and a source spreadsheet identifier may be received from a source spreadsheet. This action may be carried out for example by the action of the source spreadsheet application 124 first introduced in FIG. 1. At block 304 the dropdown list may be packaged as a favorite by action of the source spreadsheet application 124 or, in some embodiments, the spreadsheet server 112, also introduced in FIG. 1.

At block 306 an extended column address may be published (for example by the spreadsheet server 112) and made selectable by at least one destination spreadsheet application. The extended column address may be published to a link server 114 by the spreadsheet server 112, having received the extended column address from the source spreadsheet application 124, as illustrated in FIG. 1. The destination spreadsheet application 126 may access the extended column address over the data communication network 110 through the interaction of the source spreadsheet application machine 106 and the spreadsheet server 112, as well as the spreadsheet server 112 and the link server 114.

At block 312, control settings for feedback modifications may be received from a source spreadsheet application 124. These settings may control whether or not modifications made at a destination spreadsheet application 126 may be fed back to and result in modification of a source column in the source spreadsheet. These settings may be sent to the spreadsheet server 112 in order to manage propagation of feedback from destination spreadsheets to source spreadsheets maintained by the spreadsheet server 112 on the grid database 116, as illustrated in FIG. 1.

Likewise, at block 314, a control setting may be received from a destination spreadsheet application 126 to enable or suppress propagation of changes to a source column of a source spreadsheet application from presenting in a dropdown list in a destination spreadsheet. The control setting may be sent to the spreadsheet server 112 in order to manage propagation of update from source spreadsheets to destination spreadsheets maintained by the spreadsheet server 112 on the grid database 116. These control settings may be fine-grained to control propagation of deletions, additions, and/or changes specifically.

At block 308, a selection of an extended column address, along with a destination column identifier in a destination spreadsheet, may be received. The selection may be made in the destination spreadsheet application 126 and transmitted to the spreadsheet server 112.

At block 310, the selection of the extended column address and destination spreadsheet column identifier received at block 308 may be used to associate the destination column with the extended column address such that values of the source column may be presented in a dropdown list for cells of the destination column in response to activation of the destination column cells in the destination spreadsheet application 126. The association may be accomplished by the spreadsheet server 112.

At block 316 a tool tip or other type of notification may be generated to indicate a change to a source column and may be communicated to the destination spreadsheet application 126. The tool tip may be generated by the spreadsheet server 112 and communicated to the destination spreadsheet application 126 on the destination spreadsheet application machine 108 by means of the data communication network 110, as illustrated in FIG. 1.

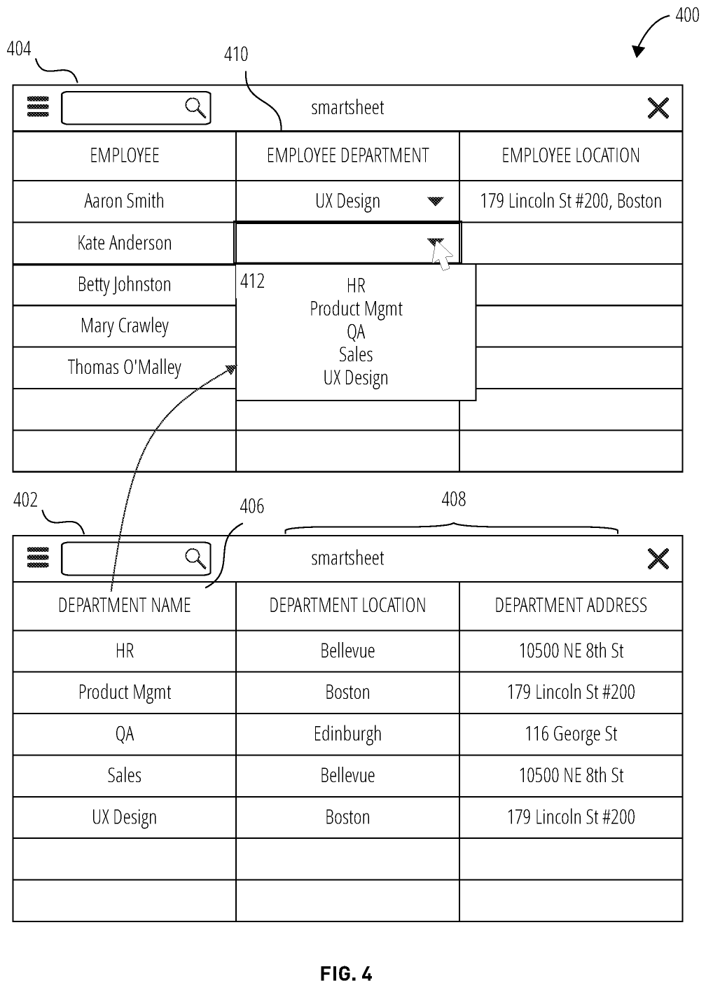

FIG. 4 through FIG. 9 depict a set of application user interfaces that may be applied in conjunction with the processes described in conjunction with FIG. 1 and FIG. 2. The application user interfaces illustrated show only some examples of possible user controls that may be used to implement the disclosed solution. One of ordinary skill in the art will recognize that user interface design is not limited to the illustrations presented.

The application interface for linking spreadsheets 400 depicted in FIG. 4 comprises an exemplary source spreadsheet 402 and destination spreadsheet 404. These user interface elements are operated and/or referenced by the operator as follows.

A source spreadsheet operator may create a source spreadsheet 402 as shown, comprising geographical data for various departments of a business. The source spreadsheet 402 may include a source column 406 containing department names. The source spreadsheet 402 may further comprise dependent or related data 408, such as the department location in the form of a city name and the department street address.

A destination spreadsheet operator may in turn create a destination spreadsheet 404 including department information for a list of employees. They may thus create a destination column 410 within the destination spreadsheet 404 for employee departments. This column may be defined as a dropdown column. In defining this column as a dropdown column, the operator may select the source column 406 of the source spreadsheet 402 shown to be the source for data to be displayed in the dropdown list 412 associated with data entry into this column.

In the illustrated example, then, the destination spreadsheet operator may select from the various departments of the business to build an employee directory listing. If employee “Aaron Smith” works in the “UX Design” department, that department may be selected from the dropdown list generated from the values in the source column 406. In some embodiments, should only one location be associated with that department in the source spreadsheet 402, the destination spreadsheet may be configured to capture and automatically enter the dependent or related data 408 from the source spreadsheet 402 into additional columns of the destination spreadsheet 404. In other embodiments, this data may need to be selected through an additional dropdown list in the appropriate column. This list may be configured such that selection of the employee department automatically filters the values available for employee location.

In some embodiments, should the “UX Design” department be renamed to, for example, “Design Development”, this change may be made in the source column of the source spreadsheet 402. If the destination spreadsheet 404 is configured to accept automatic updates, any listing of “UX Design” in the destination column 410 will change to “Design Development”. Alternatively, the destination spreadsheet 404 may be configured to notify the destination spreadsheet operator of the change when the destination spreadsheet 404 is next accessed, and the operator may elect to accept or ignore the changes into the destination column 410.

In some embodiments, a source spreadsheet 402 may be configured to accept feedback modifications from destination spreadsheets. For example, a destination spreadsheet operator may be updating an employee directory to include an acquired Manufacturing business unit not yet reflected in the source spreadsheet 402. The destination spreadsheet operator may in this case configure the dropdown list 412 to include “Manufacturing” and may enter the location of the new unit. In these embodiments, such a change may result in “Manufacturing” being added to the source column 406 of the source spreadsheet 402, as well as the appropriate dependent or related data 408. This source column 406 value may then be available to other operators using this source column 406 from this source spreadsheet 402.

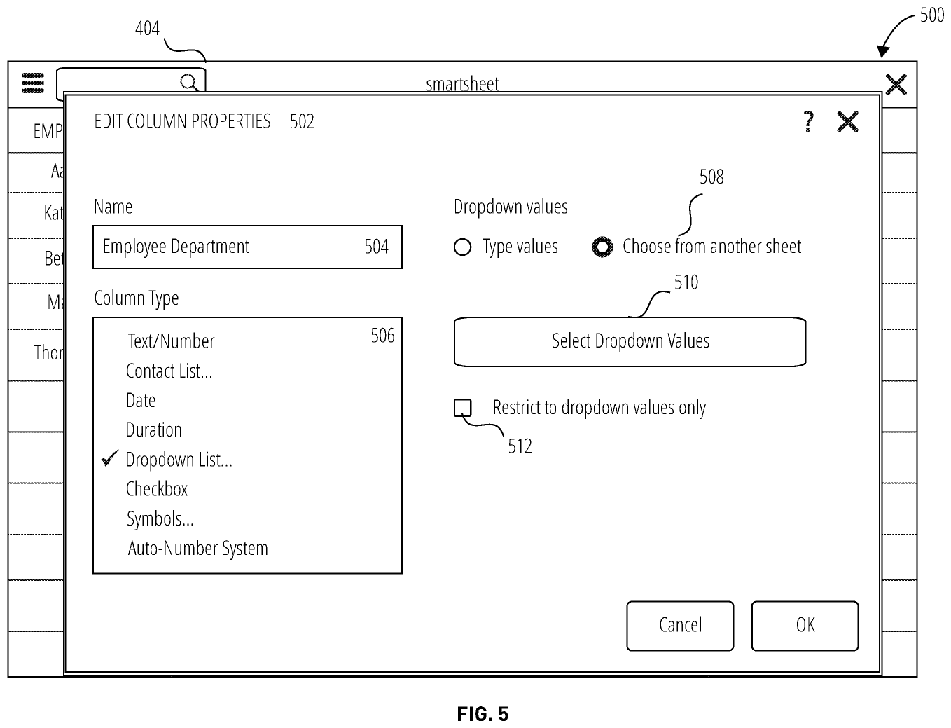

The application interface for linking spreadsheets 500 depicted in FIG. 5 comprises an edit column properties dialog 502 that may be displayed when adding a column to a spreadsheet, such as the destination spreadsheet 404 of FIG. 4. The user interface elements indicated are operated and/or referenced by the operator as follows.

The edit column properties dialog 502 may include a column name entry field 504, where the operator may enter a name, such as “Employee Department” for their spreadsheet column. The edit column properties dialog 502 may further include column type selection options 506. Multiple column types may be available for selection. For the purposes of the disclosed solution, “Dropdown List . . . ” is the column type of interest. An ellipsis (“ . . . ”) following the column type may indicate that additional options may be offered and selected when that column type is indicated.

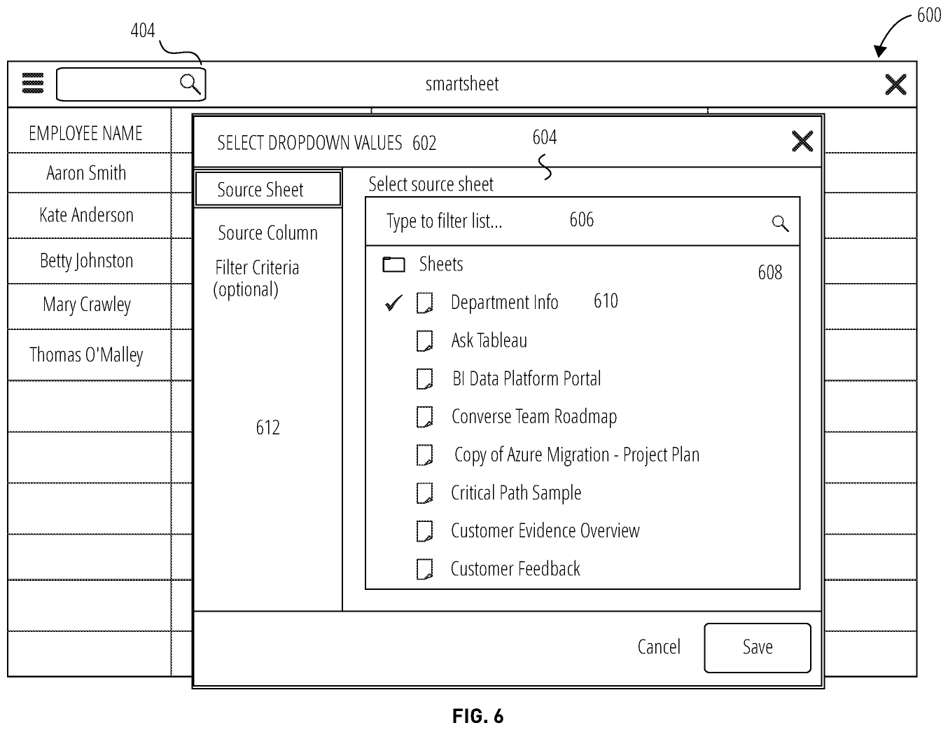

When they dropdown list column type is selected, a radio button feature may offer the choice to enter or type values in without linking to a source spreadsheet, or to select dropdown values from a source spreadsheet 508. A select dropdown values button 510 may be clicked to begin that process. For example, clicking the select dropdown values button 510 may open a dialog such as the one illustrated in FIG. 6.

A restrict to dropdown values selection box 512 may be offered to enable the operator to confine values entered in the destination column 410 to those available in the source column 406 when checked, or to enable the inclusion of additional values in the column beyond what's configured in the source column 406.

The application interface for linking spreadsheets 600 depicted in FIG. 6 comprises a select dropdown values dialog 602 that may be displayed as a result of an operator clicking the select dropdown values button 510 illustrated in FIG. 5. The user interface elements shown are operated and/or referenced by the operator as follows.

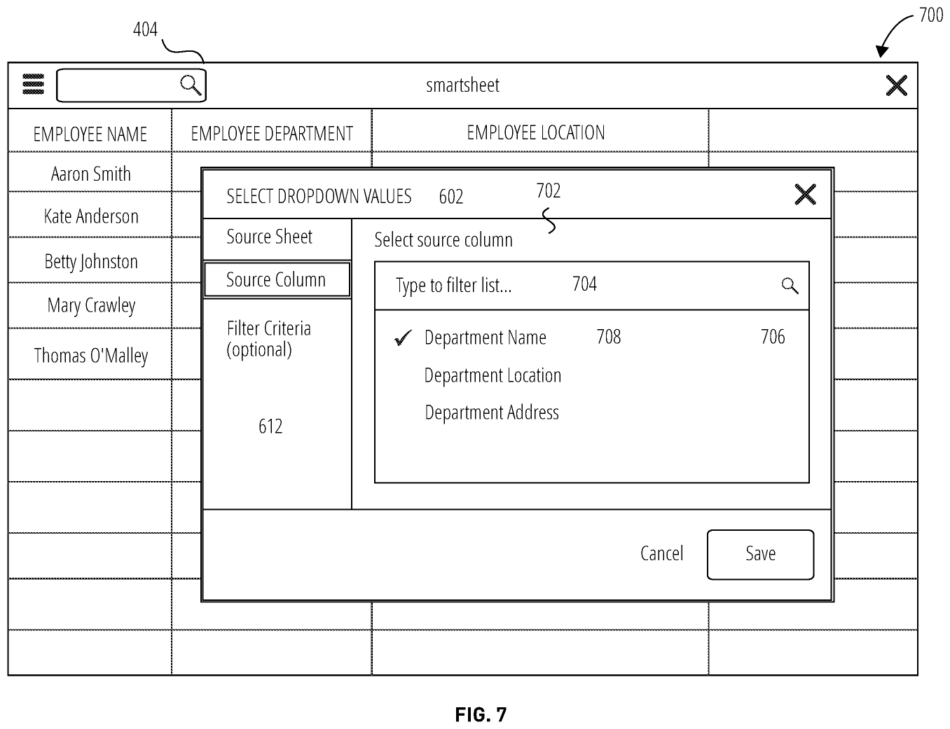

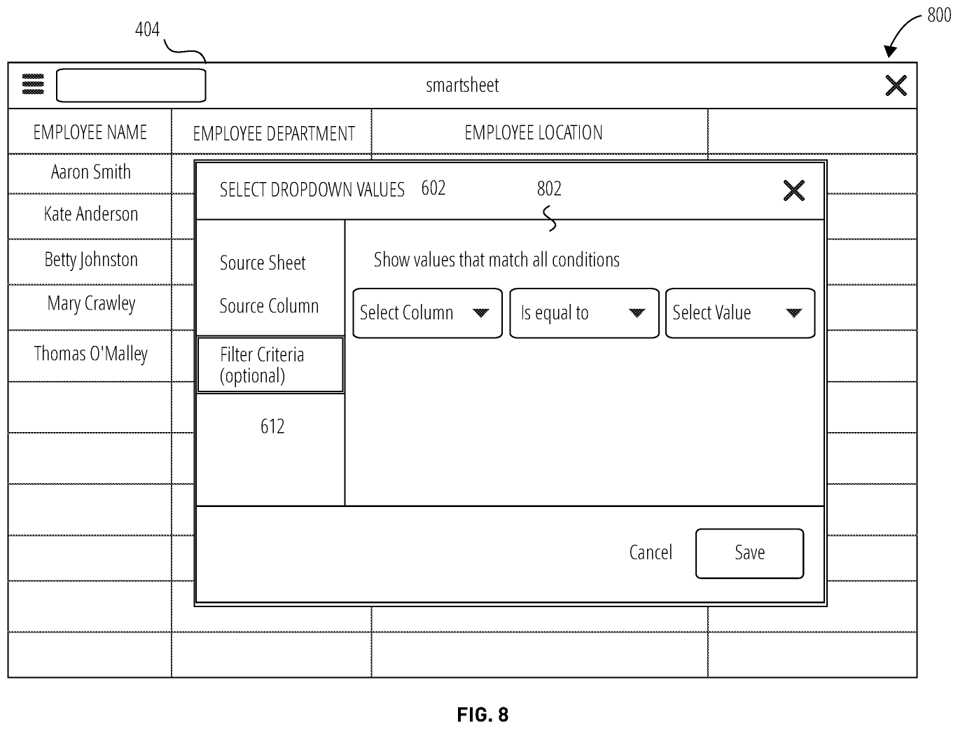

The select dropdown values dialog 602 may initially display with source spreadsheet selection options 604 shown. A left-hand selection pane 612 may be provided to allow the operator to navigate between the source spreadsheet selection options 604 and the source column selection options 702 and filter criteria selection options 802 illustrated in FIG. 7 and FIG. 8, respectively.

The source spreadsheet selection options 604 may include a source spreadsheet search bar 606 where an operator may begin typing a sheet name if the name of the desired sheet is known. Available source spreadsheets 608 may be listed below the source spreadsheet search bar 606. The available source spreadsheets 608 may include a listing of every available source spreadsheet or may be filtered based on characters typed in the source spreadsheet search bar 606.

A desired sheet may be selected from the available source spreadsheets 608 for example by “clicking” the desired sheet identifier. The selected source spreadsheet 610 may be indicated with highlighting or a checkmark or some other visual indicator.

The application interface for linking spreadsheets 700 depicted in FIG. 7 comprises a select dropdown values dialog 602 that may be displayed as a result of clicking the “Source Column” option shown in the left-hand selection pane 612 in FIG. 6. The user interface elements illustrated are operated and/or referenced by the operator as follows.

When “Source Column” is selected in the left-hand selection pane 612, source column selection options 702 may be displayed, based on the source spreadsheet selected through the source spreadsheet selection options 604 of FIG. 6. The source column selection options 702 may include a source column search bar 704 and a list of available source columns 706. An operator may type a column name in the source column search bar 704 if the name of the desired source column is known. The available source columns 706 list may display all available source columns or may show a filtered list based on characters typed into the source column search bar 704.

A desired column may be selected from the available source columns 706 by clicking. The selected source column 708 may be indicated with highlighting or a checkmark or some other visual indicator.

The application interface for linking spreadsheets 800 depicted in FIG. 8 comprises a select dropdown values dialog 602 that may be displayed as a result of an operator clicking the “Filter Criteria” option shown in the left-hand selection pane 612 in FIG. 6. The user interface elements shown are operated and/or referenced by the operator as follows.

When “Filter Criteria” is selected in the left-hand selection pane 612, the select dropdown values dialog 602 may display filter criteria selection options 802. The filter criteria selection options 802 may allow the operator to set a filter on values allowed for use in the destination column. The filter value may reference a cell in the sheet comprising a filter value, and the filter value in turn may be result of a formula evaluation comprising references to the values determined in other cells.

Once the operator has made the desired selections in the three panes of the select dropdown values dialog 602, the operator may click the save button to save the selections for the new destination column.

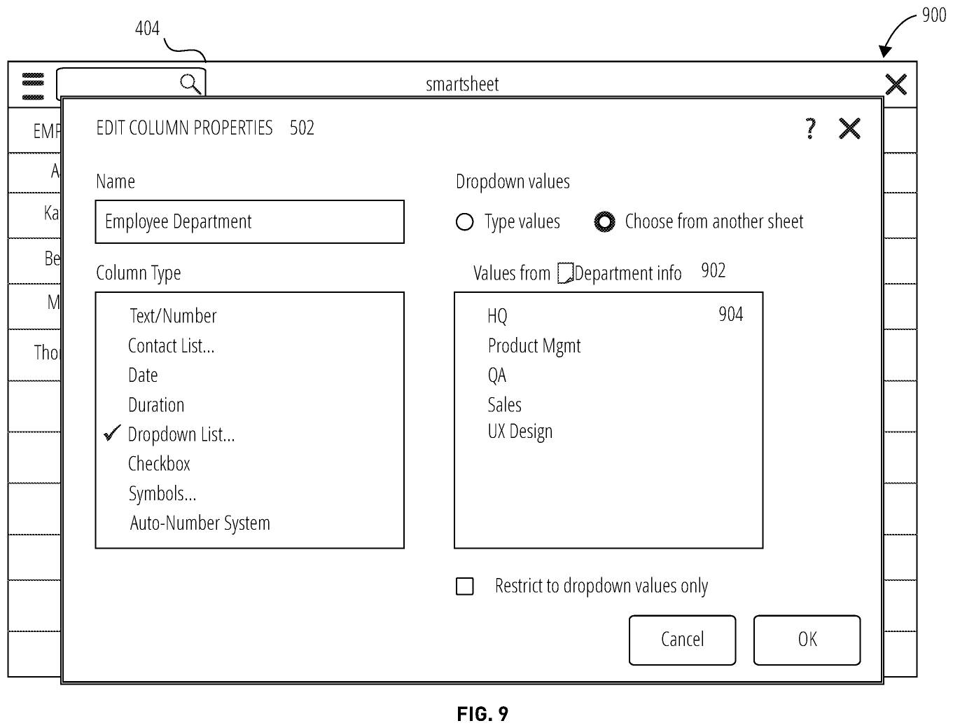

The application interface for linking spreadsheets 900 depicted in FIG. 9 comprises an edit column properties dialog 502 with selections from the select dropdown values dialog 602 now shown. These may include the selected source spreadsheet 902 and the selected source column values 904 illustrated in the right half of the edit column properties dialog 502. When satisfied with these selections, an operator may click the “OK” button to close the edit column properties dialog 502, with the destination column of the destination spreadsheet 404 now completely defined and set up for use.

### Machine Embodiments

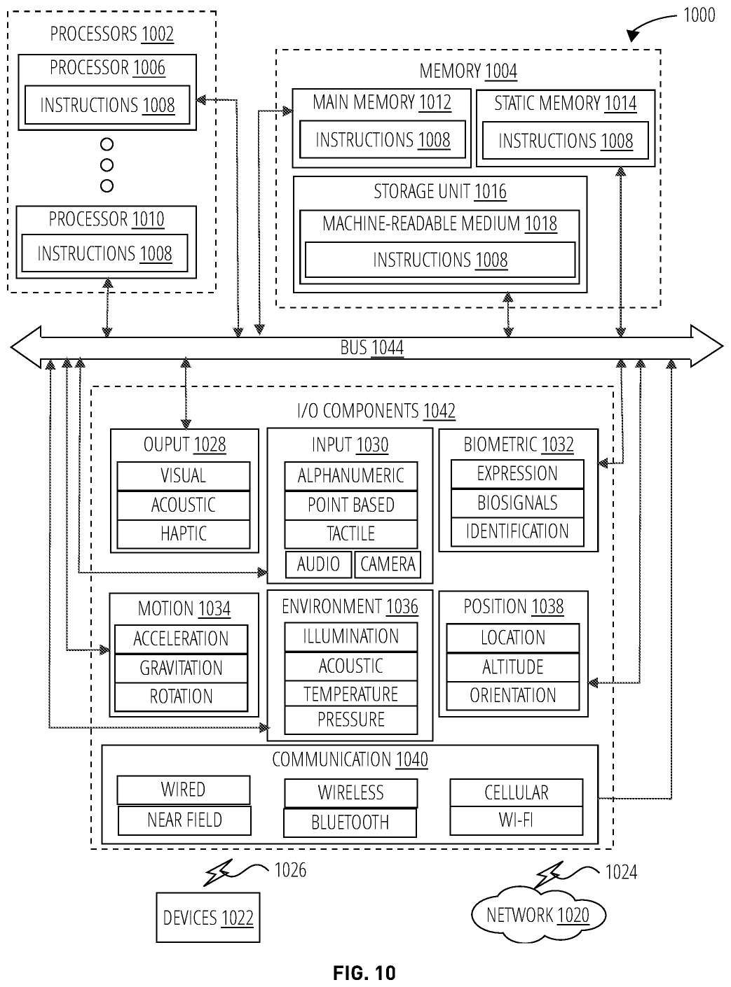

FIG. 10 depicts a diagrammatic representation of a machine 1000 in the form of a computer system within which logic may be implemented to cause the machine to perform any one or more of the functions or methods disclosed herein, according to an example embodiment.

Specifically, FIG. 10 depicts a machine 1000 comprising instructions 1008 (e.g., a program, an application, an applet, an app, or other executable code) for causing the machine 1000 to perform any one or more of the functions or methods discussed herein. For example the instructions 1008 may cause the machine 1000 to carry out aspects of the spreadsheet application linking routine 200 and/or spreadsheet application linking routine 300. The instructions 1008 configure a general, non-programmed machine into a particular machine 1000 programmed to carry out said functions and/or methods.

In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1008, sequentially or otherwise, that specify actions to be taken by the machine 1000. Further, while only a single machine 1000 is depicted, the term “machine” shall also be taken to include a collection of machines that individually or jointly execute the instructions 1008 to perform any one or more of the methodologies or subsets thereof discussed herein.

The machine 1000 may include processors 1002, memory 1004, and I/O components 1042, which may be configured to communicate with each other such as via one or more bus 1044. In an example embodiment, the processors 1002 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, one or more processor (e.g., processor 1006 and processor 1010) to execute the instructions 1008. The term “processor” is intended to include multi-core processors that may comprise two or more independent processors (sometimes referred to as “cores”) that may execute instructions contemporaneously. Although FIG. 10 depicts multiple processors 1002, the machine 1000 may include a single processor with a single core, a single processor with multiple cores (e.g., a multi-core processor), multiple processors with a single core, multiple processors with multiples cores, or any combination thereof.

The memory 1004 may include one or more of a main memory 1012, a static memory 1014, and a storage unit 1016, each accessible to the processors 1002 such as via the bus 1044. The main memory 1012, the static memory 1014, and storage unit 1016 may be utilized, individually or in combination, to store the instructions 1008 embodying any one or more of the functionality described herein. The instructions 1008 may reside, completely or partially, within the main memory 1012, within the static memory 1014, within a machine-readable medium 1018 within the storage unit 1016, within at least one of the processors 1002 (e.g., within the processor's cache memory), or any suitable combination thereof, during execution thereof by the machine 1000.

The I/O components 1042 may include a wide variety of components to receive input, provide output, produce output, transmit information, exchange information, capture measurements, and so on. The specific I/O components 1042 that are included in a particular machine will depend on the type of machine. For example, portable machines such as mobile phones will likely include a touch input device or other such input mechanisms, while a headless server machine will likely not include such a touch input device. It will be appreciated that the I/O components 1042 may include many other components that are not shown in FIG. 10. The I/O components 1042 are grouped according to functionality merely for simplifying the following discussion and the grouping is in no way limiting. In various example embodiments, the I/O components 1042 may include output components 1028 and input components 1030. The output components 1028 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1030 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), one or more cameras for capturing still images and video, and the like.

In further example embodiments, the I/O components 1042 may include biometric components 1032, motion components 1034, environmental components 1036, or position components 1038, among a wide array of possibilities. For example, the biometric components 1032 may include components to detect expressions (e.g., hand expressions, facial expressions, vocal expressions, body gestures, or eye tracking), measure bio-signals (e.g., blood pressure, heart rate, body temperature, perspiration, or brain waves), identify a person (e.g., voice identification, retinal identification, facial identification, fingerprint identification, or electroencephalogram-based identification), and the like. The motion components 1034 may include acceleration sensor components (e.g., accelerometer), gravitation sensor components, rotation sensor components (e.g., gyroscope), and so forth. The environmental components 1036 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1038 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1042 may include communication components 1040 operable to couple the machine 1000 to a network 1020 or devices 1022 via a coupling 1024 and a coupling 1026, respectively. For example, the communication components 1040 may include a network interface component or another suitable device to interface with the network 1020. In further examples, the communication components 1040 may include wired communication components, wireless communication components, cellular communication components, Near Field Communication (NFC) components, Bluetooth® components (e.g., Bluetooth® Low Energy), WiFi® components, and other communication components to provide communication via other modalities. The devices 1022 may be another machine or any of a wide variety of peripheral devices (e.g., a peripheral device coupled via a USB).

Moreover, the communication components 1040 may detect identifiers or include components operable to detect identifiers. For example, the communication components 1040 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1040, such as location via Internet Protocol (IP) geolocation, location via Wi-Fi® signal triangulation, location via detecting an NFC beacon signal that may indicate a particular location, and so forth.

### Instruction and Data Storage Medium Embodiments

The various memories (i.e., memory 1004, main memory 1012, static memory 1014, and/or memory of the processors 1002) and/or storage unit 1016 may store one or more sets of instructions and data structures (e.g., software) embodying or utilized by any one or more of the methodologies or functions described herein. These instructions (e.g., the instructions 1008), when executed by processors 1002, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors and internal or external to computer systems. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such intangible media, at least some of which are covered under the term “signal medium” discussed below.

### Communication Network Embodiments

In various example embodiments, one or more portions of the network 1020 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1020 or a portion of the network 1020 may include a wireless or cellular network, and the coupling 1024 may be a Code Division Multiple Access (CDMA) connection, a Global System for Mobile communications (GSM) connection, or another type of cellular or wireless coupling. In this example, the coupling 1024 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1008 and/or data generated by or received and processed by the instructions 1008 may be transmitted or received over the network 1020 using a transmission medium via a network interface device (e.g., a network interface component included in the communication components 1040) and utilizing any one of a number of well-known transfer protocols (e.g., hypertext transfer protocol (HTTP)). Similarly, the instructions 1008 may be transmitted or received using a transmission medium via the coupling 1026 (e.g., a peer-to-peer coupling) to the devices 1022. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1008 for execution by the machine 1000, and/or data generated by execution of the instructions 1008, and/or data to be operated on during execution of the instructions 1008, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Software Implementations

Particular terms are used in the following description and should be understood as follows.

“App” refers to a type of application with limited functionality, most commonly associated with applications executed on mobile devices. Apps tend to have a more limited feature set and simpler user interface than applications as those terms are commonly understood in the art.

“Application” refers to any software that is executed on a device above a level of the operating system. An application will typically be loaded by the operating system for execution and will make function calls to the operating system for lower-level services. An application often has a user interface but this is not always the case. Therefore, the term ‘application’ includes background processes that execute at a higher level than the operating system.

“Application program interface” refers to instructions implementing entry points and return values to a module.

“Computer program” refers to another term for ‘application’ or ‘app’.

“Instructions” refers to symbols representing commands for execution by a device using a processor, microprocessor, controller, interpreter, or other programmable logic. Broadly, ‘instructions’ can mean source code, object code, and executable code. ‘instructions’ herein is also meant to include commands embodied in programmable read-only memories (EPROM) or hard coded into hardware (e.g., ‘micro-code’) and like implementations wherein the instructions are configured into a machine memory or other hardware component at manufacturing time of a device.

“Module” refers to a computer code section having defined entry and exit points. Examples of modules are any software comprising an application program interface, drivers, libraries, functions, and subroutines.

“Operating system” refers to logic, typically software, that supports a device's basic functions, such as scheduling tasks, managing files, executing applications, and interacting with peripheral devices. In normal parlance, an application is said to execute “above” the operating system, meaning that the operating system is necessary in order to load and execute the application and the application relies on modules of the operating system in most cases, not vice-versa. The operating system also typically intermediates between applications and drivers. Drivers are said to execute “below” the operating system because they intermediate between the operating system and hardware components or peripheral devices.

“Process” refers to software that is in the process of being executed on a device.

“Programmable device” refers to any logic (including hardware and software logic) who's operational behavior is configurable with instructions.

“Service” refers to a process configurable with one or more associated policies for use of the process. Services are commonly invoked on server devices by client devices, usually over a machine communication network such as the Internet. Many instances of a service may execute as different processes, each configured with a different or the same policies, each for a different client.

“Software” refers to logic implemented as instructions for controlling a programmable device or component of a device (e.g., a programmable processor, controller). Software can be source code, object code, executable code, machine language code. Unless otherwise indicated by context, software shall be understood to mean the embodiment of said code in a machine memory or hardware component, including “firmware” and micro-code.

“Task” refers to one or more operations that a process performs.

The systems disclosed herein, or particular components thereof, may in some embodiments be implemented as software comprising instructions executed on one or more programmable device. By way of example, components of the disclosed systems may be implemented as an application, an app, drivers, or services. In one particular embodiment, the system is implemented as a service that executes as one or more processes, modules, subroutines, or tasks on a server device so as to provide the described capabilities to one or more client devices over a network. However the system need not necessarily be accessed over a network and could, in some embodiments, be implemented by one or more app or applications on a single device or distributed between a mobile device and a computer, for example.

In another particular embodiment, one or more of the spreadsheet application linking logic 122, source spreadsheet application 124, and destination spreadsheet application 126 previously described are implemented as software, with the spreadsheet application linking logic 122 implemented as a service and the source spreadsheet application 124 and destination spreadsheet application 126 implemented as applications.

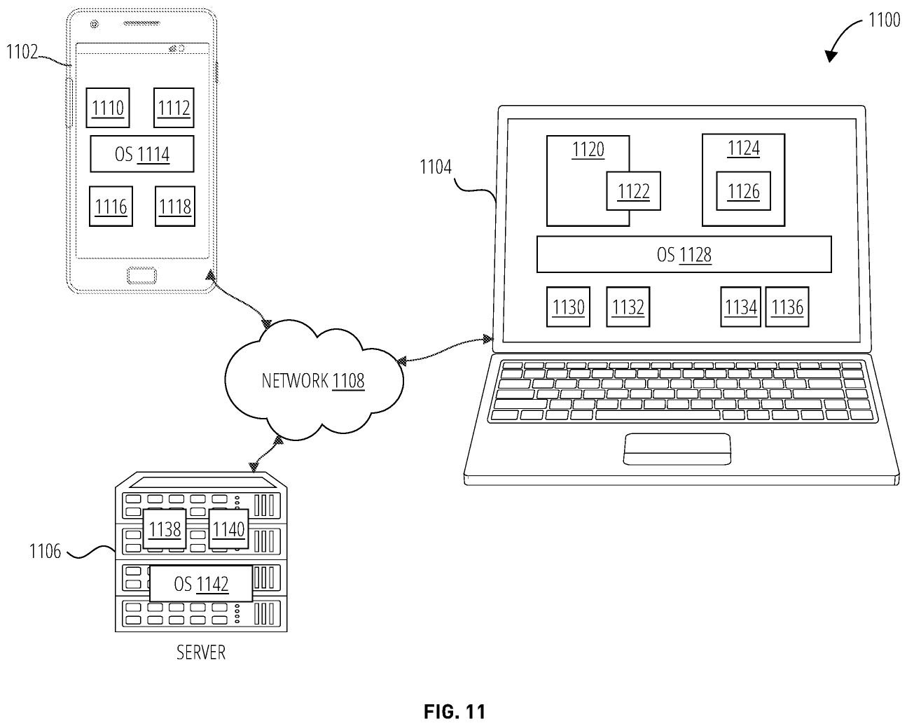

Referring to FIG. 11, a client server network configuration 1100 illustrates various computer hardware devices and software modules coupled by a network 1108 in one embodiment. Each device includes a native operating system, typically pre-installed on its non-volatile RAM, and a variety of software applications or apps for performing various functions.

The mobile programmable device 1102 comprises a native operating system 1114 and various apps (e.g., app 1110 and app 1112). A computer 1104 also includes an operating system 1128 that may include one or more library of native routines to run executable software on that device. The computer 1104 also includes various executable applications (e.g., application 1120 and application 1124). The mobile programmable device 1102 and computer 1104 are configured as clients on the network 1108. A server 1106 is also provided and includes an operating system 1142 with native routines specific to providing a service (e.g., service 1140 and service 1138) available to the networked clients in this configuration.

As is well known in the art, an application, an app, or a service may be created by first writing computer code to form a computer program, which typically comprises one or more computer code sections or modules. Computer code may comprise instructions in many forms, including source code, assembly code, object code, executable code, and machine language. Computer programs often implement mathematical functions or algorithms and may implement or utilize one or more application program interfaces.

A compiler is typically used to transform source code into object code and thereafter a linker combines object code files into an executable application, recognized by those skilled in the art as an “executable”. The distinct file comprising the executable would then be available for use by the computer 1104, mobile programmable device 1102, and/or server 1106. Any of these devices may employ a loader to place the executable and any associated library in memory for execution. The operating system executes the program by passing control to the loaded program code, creating a task or process. An alternate means of executing an application or app involves the use of an interpreter (e.g., interpreter 1126).

In addition to executing applications (“apps”) and services, the operating system is also typically employed to execute drivers to perform common tasks such as connecting to third-party hardware devices (e.g., printers, displays, input devices), storing data, interpreting commands, and extending the capabilities of applications. For example, a driver 1116 or driver 1118 on the mobile programmable device 1102 or computer 1104 (e.g., driver 1130 and driver 1132) might enable wireless headphones to be used for audio output(s) and a camera to be used for video inputs. Any of the devices may read and write data from and to files (e.g., file 1134 or file 1136) and applications or apps may utilize one or more plug-in (e.g., plug-in 1122) to extend their capabilities (e.g., to encode or decode video files).

The network 1108 in the client server network configuration 1100 can be of a type understood by those skilled in the art, including a Local Area Network (LAN), Wide Area Network (WAN), Transmission Communication Protocol/Internet Protocol (TCP/IP) network, and so forth. These protocols used by the network 1108 dictate the mechanisms by which data is exchanged between devices.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

“Logic” refers to machine memory circuits, non-transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

What is claimed is:

1. A method comprising:
defining, in a source spreadsheet application, a source column for a dropdown list;
forming an extended column address for the source column from a spreadsheet identifier for the source spreadsheet application and the source column;
publishing the extended column address on a link server;
associating, in a destination spreadsheet application, a destination column with the extended column address; and
presenting values of the dropdown list in response to activation of cells of the destination column in the destination spreadsheet application.

2. The method of claim 1, further comprising:
associating the dropdown list with a filter cell in the destination spreadsheet application; and
filtering the presentation of the dropdown list based on a value in the filter cell.

3. The method of claim 1, further comprising:
packaging the dropdown list as a favorite.

4. The method of claim 1, further comprising:
configuring, in the source spreadsheet application, control settings for feedback modifications to the dropdown list from the destination spreadsheet application.

5. The method of claim 4, wherein the feedback modifications comprise one or more of adding values to the dropdown list, deleting values from the dropdown list, and changing values in the dropdown list.

6. The method of claim 1, further comprising:
configuring a control setting in the destination spreadsheet application to enable or suppress propagation of changes to the source column of the source spreadsheet application from presenting in the dropdown list in the destination spreadsheet application.

7. The method of claim 1, further comprising:
presenting in the destination spreadsheet application a tool tip indication of a change to the source column.

8. The method of claim 1, wherein the source column comprises one or more of text, numbers, and dates.

9. A method executed on a computer server in a data communication network, the method comprising:
receiving, from a source spreadsheet application, a source column identifier and a source spreadsheet identifier;
publishing an extended column address comprising the source column identifier and the source spreadsheet identifier;
making the extended column address selectable over the data communication network by at least one destination spreadsheet application;
receiving, from the at least one destination spreadsheet application, a selection of the extended column address and a destination column identifier in a destination spreadsheet; and
associating the destination column with the extended column address such that values of the source column are presented in a dropdown list for cells of the destination column in response to activation of cells of the destination column in the destination spreadsheet application.

10. The method of claim 9, further comprising:
packaging the dropdown list as a favorite.

11. The method of claim 9, further comprising:
receiving, from the source spreadsheet application, control settings for feedback modifications to the source column from the destination spreadsheet application.

12. The method of claim 11, wherein the feedback modifications comprise one or more of adding values to the source column, deleting values from the source column, and changing the values of the source column.

13. The method of claim 9, further comprising:
receiving from the destination spreadsheet application a control setting to enable or suppress propagation of changes to the source column of the source spreadsheet application from presenting in the dropdown list in the destination spreadsheet.

14. The method of claim 9, further comprising:
generating a tool tip indication of a change to the source column and communicating the tool tip to the destination spreadsheet application.

15. A non-transitory computer-readable storage medium, the computer-readable storage medium including instructions that when executed by a computer, cause the computer to:
publish an extended column address formed from a source column identifier and a source spreadsheet identifier;
receive, from at least one destination spreadsheet application, a selection of the extended column address and a destination column identifier in a destination spreadsheet; and
propagate values of the source column to a dropdown list presented for cells of the destination column.

16. The computer-readable storage medium of claim 15, wherein the instructions further configure the computer to:
package the dropdown list as a selectable favorite by the destination spreadsheet application.

17. The computer-readable storage medium of claim 15, wherein the instructions further configure the computer to:
apply control settings for feedback modifications to the source column from the destination spreadsheet application.

18. The computer-readable storage medium of claim 17, wherein the feedback modifications comprise one or more of propagating added values from the destination spreadsheet application to the source column, propagating deleting values from the destination spreadsheet application to the source column, and propagating changed values from the destination spreadsheet application to the source column.

19. The computer-readable storage medium of claim 15, wherein the instructions further configure the computer to:
apply a control setting to enable or suppress propagation of changes to the source column of a source spreadsheet application from presenting in the dropdown list in the destination spreadsheet application.

20. The computer-readable storage medium of claim 15, wherein the instructions further configure the computer to:
generate a tool tip indication of a change to the source column and communicate the tool tip to the destination spreadsheet application.
